(19) United States
(12) Patent Application Publication
(10) Pub. No.: US 2026/0222170 A1
(43) Pub. Date: Jul. 30, 2026

(54) CORRECTION OF PHASE INTERPOLATOR AND DELAY-LOCKED LOOP ERRORS IN CLOCK AND DATA RECOVERY LOOP

(71) Applicant: Marvell Asia Pte Ltd, Singapore (SG)

(72) Inventors: Manisha Gambhir, Cupertino, CA (US); Ahmed Mostafa, San Jose, CA (US); Davide Visani, San Jose, CA (US); Mehedi Hasan, San Jose, CA (US)

(73) Assignee: Marvell Asia Pte Ltd, Singapore (SG)

(21) Appl. No.: 19/462,076

(22) Filed: Jan. 28, 2026

Related U.S. Application Data
(60) Provisional application No. 63/751,781, filed on Jan. 30, 2025.
(60) Provisional application No. 63/751,774, filed on Jan. 30, 2025.

(51) Int. Cl. H04L 7/00

(52) U.S. Cl. CPC H04L 7/002

(57) ABSTRACT

A phase interpolator (PI) is controlled by digital PI-codes generated by a clock and data recovery (CDR) loop in a high-speed receiver. PI-code monitoring and correction is included in the loop to detect and correct non-linearity in the PI and/or phase errors in a delay-locked loop (DLL) that feeds into the PI. A PI-code monitor accumulates PI-codes into bins and analyzes the resulting distribution to detect non-linearity in the PI. A correction table is generated based on the observed PI-code distribution. A PI-code corrector uses this table to adjust subsequent PI-codes, compensating for non-ideal analog behavior. The architecture enables real-time monitoring and digital correction of PI and DLL errors, improving timing alignment in high-speed links with shared phase-locked loops (PLLs) and per-lane DLLs and PIs.

### PRIORITY APPLICATION

This patent application claims priority to and/or receives benefit from U.S. Provisional Application No. 63/751,774, titled, “Statistical All-digital Detection of Delay Locked Loop and Phase-interpolator Non-linearity for High Speed Links and CDRs”, filed on Jan. 30, 2025, and Provisional Application No. 63/751,781, titled, “All-digital Correction of Delay Locked Loop and Phase-interpolator Non-linearity for High Speed Links and CDRs”, filed on Jan. 30, 2025. The U.S. Provisional Applications are hereby incorporated by reference in their entireties.

### BACKGROUND

High-speed, high-bandwidth communication systems are integral to modern computing and networking applications. These systems are designed to facilitate efficient and reliable data transmission over various media, including optical fibers, copper cables, and wireless channels. Advances in communication technologies, such as signal modulation, error correction, and clock recovery, can ensure data integrity, reduce latency, and maintain synchronization across devices.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary electronics system, according to some embodiments of the disclosure.

FIG. 2 illustrates an implementation of a clock and data recovery (CDR) loop, according to some embodiments of the disclosure.

FIG. 3 illustrates an implementation of a CDR loop with a Phase Interpolator code (PI-code) monitoring and correction, according to some embodiments of the disclosure.

FIG. 4 illustrates an example PI-code monitor, according to some embodiments of the disclosure.

FIG. 5 provides a visual representation of PI-codes and grouped PI-codes, according to some embodiments of the disclosure.

FIG. 6 is a first histogram representing a PI-code distribution, according to some embodiments of the disclosure.

FIG. 7 is a second histogram of the PI-code distribution of FIG. 6 with multiple PI-codes binned together in groups, according to some embodiments of the disclosure.

FIG. 8 is a flow chart illustrating a method for PI-code monitoring, according to some embodiments of the present disclosure.

FIG. 9 illustrates a first example PI-code corrector with a lookup table, according to some embodiments of the disclosure.

FIG. 10 provides a second PI-code corrector with an error table, according to some embodiments of the disclosure.

FIG. 11 depicts a flow chart illustrating a method for PI-code correction, according to some embodiments of the disclosure.

### DETAILED DESCRIPTION

### Overview

Digital signal processors (DSPs), such as optical DSPs and coherent DSPs, can enable high-bandwidth optical interconnects that deliver ultra-high throughput while optimizing for low-latency and energy-efficient data transfer. Such DSPs can offer seamless connectivity across a variety of computing environments, including AI, cloud computing, and enterprise systems, and 5G infrastructure.

In many designs, minimizing chip area is critical for devices that incorporate a DSP. Phase-locked loops (PLLs) occupy significant silicon area, so sharing a single PLL across multiple lanes is an effective strategy for optimizing area utilization. Additionally, placing multiple PLLs in close proximity can introduce noise and crosstalk; using one shared PLL for several lanes not only conserves area but also mitigates these interference issues.

A shared PLL generates a high-frequency reference clock that can be distributed to multiple lanes, e.g., to all lanes on the device. In high-speed serial links, each lane may experience unique skew and jitter, and each lane may have unique data alignment requirements. So, to tune the clock phase for each lane, the shared PLL may be coupled to a per-lane delay-locked loop (DLL) and per-lane phase interpolator (PI). The DLL receives the reference clock from the PLL and produces multiple phase-shifted versions. The PI takes these DLL-generated phases and, using a digital PI-code, interpolates between them to create a finely tuned output phase. This process enables each lane to generate a clock signal precisely aligned with its incoming data.

In high baud rate implementations (e.g., at or above 224 Gbps), the DLL and PI scheme described above may suffer from untracked errors resulting from non-linearities in the PI and/or phase generation errors in the DLL. These errors affect the link performance adversely. For example, the PI-based system, while improving on area and crosstalk as noted above, may have a greater error rate than per-lane PLL implementations.

Accordingly, to improve area-efficient shared-PLL and per-lane DLL and PI implementations, particularly for high baud rate applications, solutions that enable real-time sensing and correction of PI and DLL errors are described herein. A per-lane CDR loop that includes the per-lane DLL and PI incorporates a feedback mechanism to statistically monitor and correct non-linearities in the PI and/or phase generation errors in the DLL.

In some embodiments, a feedback loop includes a PI-code monitor that collects PI-codes generated during a period of time, e.g., while calibration data with a low frequency offset is received from a link partner. The PI-code monitor accumulates received PI-codes into one or more sets of bins. One set of bins may have a different bin for each PI-code, e.g., 256 bins if the PI uses 256 PI-codes. Another set of bins may have a different bin corresponding to each of the DLL phases, e.g., 8 bins if the DLL has 8 phase steps. Differences in counts across a set of bins indicate error in the analog subsystem. For example, different counts in the per-code bins indicate non-linearity in the PI, and different counts in the grouped bins corresponding to DLL phases indicate error in the DLL. Thus, the received codes can be analyzed by an error detector to detect these errors based on the bin counts.

In some embodiments, a feedback loop includes a PI-code corrector that adjusts PI-codes to address errors in the analog subsystem. The PI-code corrector may follow the PI-code monitor and act based on errors detected at the PI-code monitor. The PI-code corrector may generate a correction table, such as an error table or lookup table, e.g., based on the bin counts accumulated in the PI-code monitor. During operation, the PI-code corrector receives PI-codes generated by the digital CDR loop (e.g., by a PI-code accumulator that generates PI-codes for the PI) and determines a corrected PI-code according to the correction table. The PI-code corrector outputs the corrected PI-code to the PI. Using the corrected PI-codes compensates for non-ideal behavior of analog components of the CDR, such as non-linear phase generation of the PI and/or phase errors in the DLL.

While examples of PI-code monitoring and PI-code correction are described herein, and illustrated as being implemented by a single subsystem, it should be understood that, in some implementations, the monitoring may be implemented independently from the correction, or the correction may be implemented separately from the monitoring. For example, the correction may be combined with different monitoring techniques, or without certain aspects of monitoring disclosed herein. Furthermore, the monitoring may be combined with different correction techniques, or without certain aspects of the correction techniques described herein.

### Exemplary Computing System

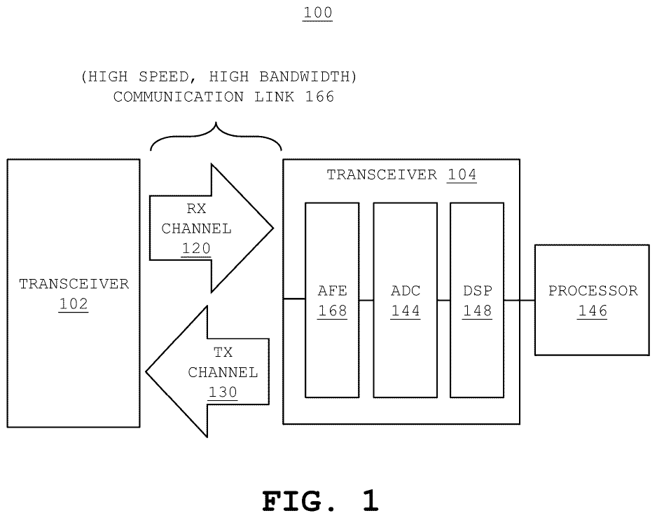

FIG. 1 illustrates an exemplary electronics system 100, according to some embodiments of the disclosure. Electronics system 100 can be used in high-speed, high-bandwidth communication applications. Electronics system 100 can include one or more components to carry out functionalities, including, among other things, effective signal transmission, reception, diagnostics, and clock recovery functionality. Electronics system 100 includes transceiver 102 and transceiver 104. Transceiver 104 can carry out communication functionalities for processor 146. For simplicity, the processor that transceiver 102 is carrying out communication functionalities is omitted in the figure.

Processor 146 may perform data processing tasks. Processor 146 can include one or more suitable types of processors, and one or more suitable number of processors. Processor 146 may be a single-core processor, or a multi-core (e.g., ARM or x86 processor cores). Examples of processor 146 may include a central processing unit (CPU), a graphics processing unit (GPU), a field-programmable gate array (FPGA), a tensor processing unit (TPU), a data processing unit (DPU), a DSP, an application specific integrated circuit (ASIC), etc. Processor 146 can execute instructions or commands of an operating system. Processor 146 can perform operations and/or computations for an application of electronics system 100.

Transceiver 104 can enable transmission and reception of signals over (high-speed, high-bandwidth) communication link 166. In this example, communication link 166 can include one or more of: receive (RX) channel 120, and transmit (TX) channel 130. RX channel 120 can have one or more RX data lanes received at transceiver 104. TX channel 130 can have one or more TX data lanes transmitted from transceiver 104.

Transceiver 102 can transmit data over RX channel 120 to transceiver 104 and can include circuitry to support transmission of data. Incoming data signals transmitted over RX channel 120 can be received by transceiver 104. Transceiver 104 has circuitry that processes the received data signals. Transceiver 104 can include an analog front-end (AFE) 168, which may include one or more amplifiers or other analog circuits to process the received data signals before the data signals are provided to one or more analog-to-digital converters (ADC) 144. For example, AFE 168 may include phase interpolator 220 and delay-locked loop 230 described below.

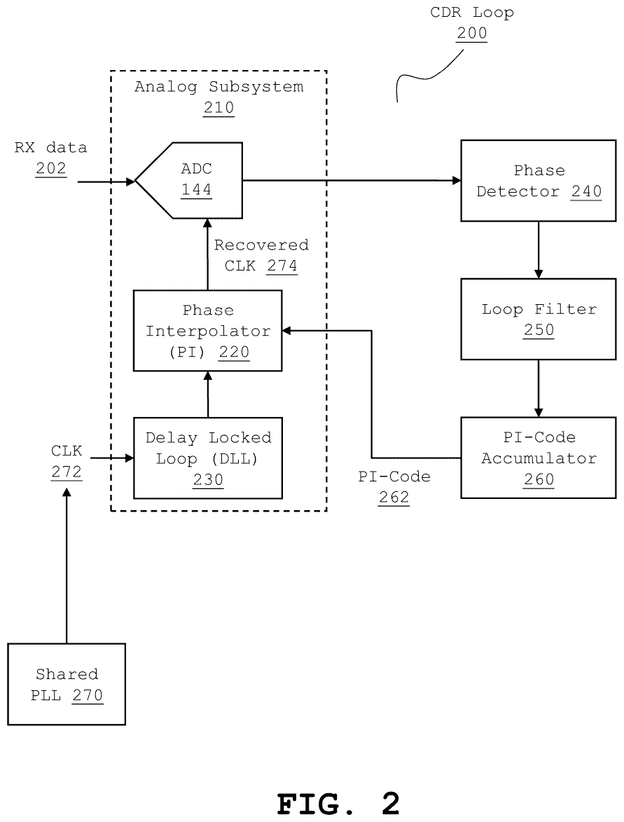

ADC 144 can digitize the analog signals and output digital outputs or digital samples for further processing by DSP 148. For high-speed, high-bandwidth data interfaces, transceiver 104 may include multiple time-interleaved ADCs used to sample an analog signal received on RX channel 120 to achieve the baud rate of the communication channel. Time-interleaved ADCs 144 can take turns, one after another, or in a randomized fashion, to sample the received analog signal at different sampling points to produce the digitized samples of the received analog signal. ADC(s) 144 and AFE 168 may be part of an analog subsystem, e.g., analog subsystem 210 described with respect to FIG. 2.

Transceiver 104 can transmit signals to transceiver 102 via TX channel 130, and transceiver 104 can include additional circuitry to prepare data signals to be transmitted over TX channel 130. Transceiver 104 can include TX circuitry to ensure faithful signal transmission over communication link 166.

DSP 148 can manage data processing tasks within transceiver 104. DSP 148 can include circuitry to perform one or more operations or computations. DSP 148 can include circuitry that can execute instructions and carry out one or more operations or computations. Examples of operations or computations can include, but are not limited to, diagnostics, control algorithms, signal processing, filtering, decision making or slicing, and equalization. Example components of DSP 148 are shown in FIGS. 2-4 and FIG. 8, described below.

While the description is focused on transceiver 104, it is envisioned that various embodiments described herein are applicable to transceiver 102. It is also envisioned that various embodiments described herein are applicable to receivers, and not necessarily transceivers.

### CDR Loop

FIG. 2 illustrates an implementation of a CDR loop 200, according to some embodiments of the disclosure. CDR loop 200 includes an analog subsystem 210, which includes ADC 144, e.g., the ADC 144 of FIG. 1. In some embodiments, CDR loop 200 corresponds to a single lane of a multi-lane receiver, where each lane has an associated ADC 144 and its own CDR loop 200. Analog subsystem 210 further includes phase interpolator (PI) 220 and delay-locked loop (DLL) 230.

ADC 144 receives RX data 202, which it samples and digitizes based on a recovered sampling clock signal 274 (referred to herein as sampling clock 274 or recovered clock 274) from PI 220. ADC 144 outputs the digitized data into the digital portion of CDR loop 200, which includes phase detector 240, loop filter 250, and PI-code accumulator 260. Phase detector 240, loop filter 250, and PI-code accumulator 260, along with shared phase-locked loop (PLL) 270, may be implemented by DSP 148.

Phase detector 240 outputs a phase error signal to loop filter 250. Loop filter 250 processes the phase error signal to filter out noise and generate a control signal that stabilizes the loop response.

PI-code accumulator 260 receives the control signal from loop filter 250 and may integrate or accumulate the filtered control signal to generate an updated PI-code 262. PI-codes 262 are digital values that represent the desired phase adjustment for PI 220; PI-codes 262 are used to adjust PI 220 for precise clock alignment to an optimal sampling point of RX data 202. PI-code accumulator 260 may generate PI-codes 262 by incrementally adjusting its accumulator's value in response to the filtered phase error from loop filter 250. An updated PI-code 262 is sent to PI 220, which uses PI-code 262 to interpolate between multiple clock phases and produce the recovered sampling clock 274 that is precisely aligned with the incoming data. By continuously updating PI-codes 262, PI-code accumulator 260 enables CDR loop 200 to track and correct timing variations, ensuring robust data recovery even in the presence of jitter or drift.

Shared PLL 270 generates a high-frequency reference clock signal, denoted as CLK 272, which is distributed to multiple lanes within transceiver 104. Within each lane, DLL 230, or another implementation of a multiphase generator, receives the reference clock signal CLK 272 from shared PLL 270 and produces multiple phase-shifted versions of this clock. These phase-shifted outputs from DLL 230 are input to PI 220. PI 220 utilizes the phase-shifted clocks, along with PI-codes 262, to interpolate and generate a finely tuned sampling clock 274 that is precisely aligned with the incoming RX data 202. PI-code 262, which is continuously updated by the PI-code accumulator 260, determines the specific phase adjustment applied by PI 220, enabling accurate timing alignment and robust data recovery in the presence of channel variations and jitter. PI 220 provides the tuned sampling clock 274 to ADC 144, which uses the tuned clock signal 274 to determine sampling instants for RX data 202.

CDR Loop with PI-Code Monitoring and Correction

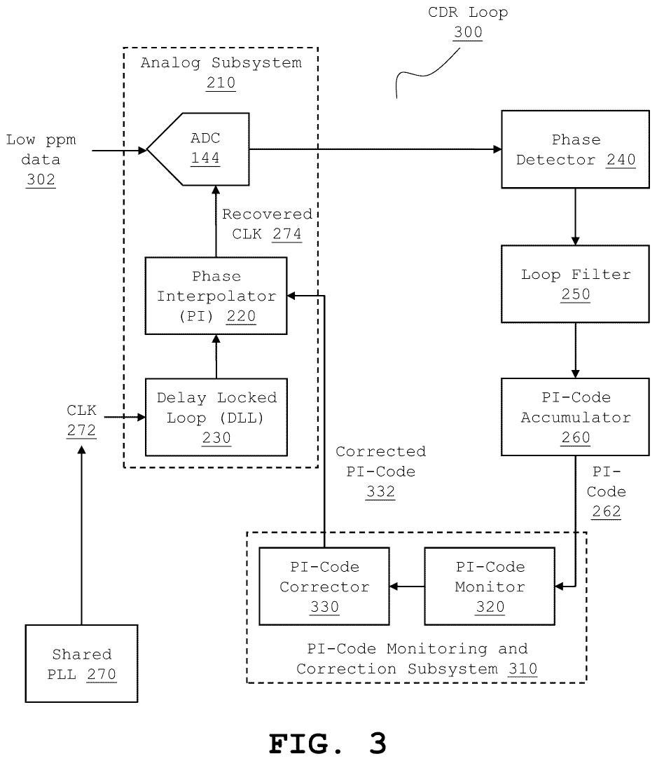

FIG. 3 illustrates an implementation of a CDR loop 300 with PI-code monitoring and correction, according to some embodiments of the disclosure. CDR loop 300 includes the analog subsystem 210 of FIG. 2, including ADC 144, PI 220, and DLL 230. CDR loop 300 further includes phase detector 240, loop filter 250, and PI-code accumulator 260 of FIG. 2.

As in FIG. 2, PI-code accumulator 260 outputs PI-codes 262, which are continually updated by PI-code accumulator 260. Unlike in FIG. 2, in CDR loop 300, PI-code 262 is provided to PI-code monitoring and correction subsystem 310, which includes PI-code monitor 320 and PI-code corrector 330. PI-code monitoring and correction subsystem 310 may be implemented using digital circuitry configured or programmed to perform the functions described below. For example, PI-code monitoring and correction subsystem 310 may be implemented on DSP 148 or other digital circuitry of transceiver 104.

PI-code monitoring and correction subsystem 310 evaluates PI-codes 262 from PI-code accumulator 260 in real-time to detect non-ideal phase behavior in CDR loop 300. As noted above, non-idealities such as non-linear behavior of PI 220 and/or phase generation errors in DLL 230 can cause the actual phase steps produced by PI 220 to deviate from their intended values. These imperfections may result from circuit mismatches, process variations, or drift over temperature and voltage, leading to uneven or missing phase steps, differential non-linearity, or phase drift. Such non-ideal phase behavior manifests as irregularities or statistical anomalies in the sequence of PI-codes 262, which can be detected through real-time monitoring at PI-code monitor 320.

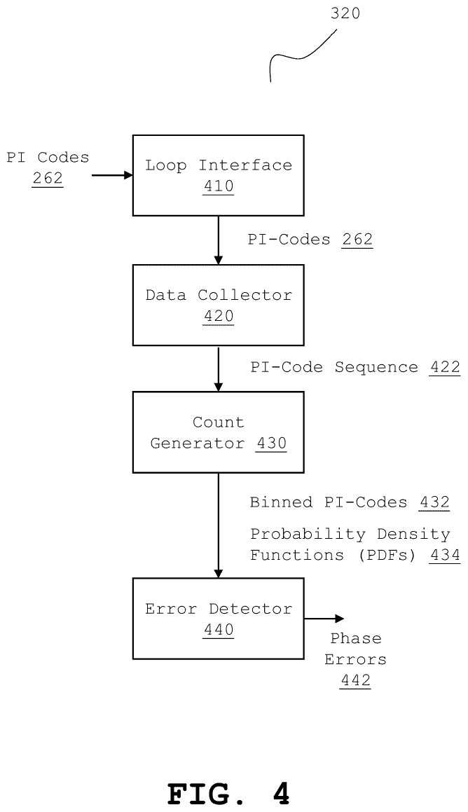

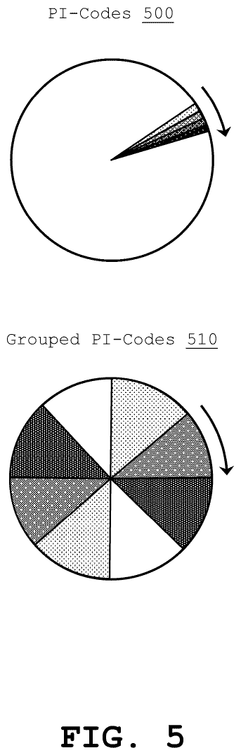

In some embodiments, PI-code monitor 320 collects data describing the stream of PI-codes 262 over a period of time and calculates statistics for monitoring based on the stream. PI-code monitor 320 can generate statistics such as counts, densities, and distributions, which may be collected on a per-code basis and/or per DLL phase sector. These statistics can identify signatures of PI non-linearity and multiphase-generation errors from DLL 230. An example block diagram of PI-code monitor 320 is provided in FIG. 4 and described below, with example statistics described with respect to FIGS. 5-7.

Using the monitoring results, PI-code corrector 330 can apply a digital correction to the received PI-codes 262 to generate corrected PI-code 332. PI-code corrector 330 may implement a lookup table or arithmetic error-mapping function that re-indexes or offsets PI-codes to linearize the effective phase step seen at PI 220, thereby compensating for PI non-linearity and DLL phase-generation errors. The corrected PI-code 332 is provided to PI 220, which interpolates among the DLL-generated phases to produce a sampling clock 274 that is aligned to the optimal sampling point of received data. PI-code monitoring and correction subsystem 310 improves robustness of CDR loop 300 and can reduce bit-error rate, particularly for high-baud-rate operations.

In some embodiments, PI-code monitoring and correction subsystem 310 operates during a low-ppm training mode, e.g., during a startup sequence, training phase, or calibration phase. Low ppm data 302 is transmitted by a link partner (e.g., transceiver 102) over RX channel 120 and received by transceiver 104. Low ppm data 302 has a very small frequency offset (e.g., several parts per million) relative to a local reference clock, resulting in a slowly varying phase relationship between the received low ppm data 302 and the sampling clock 274 generated by PI 220. This controlled condition enables CDR loop 300 to sweep through the PI-codes in a predictable manner, so that PI non-linearity and multiphase generation errors can be tracked and characterized. In particular, low ppm data 302 enables PI-code monitoring and correction subsystem 310 to collect statistical information about the distribution and behavior of PI-codes 262 under known conditions with the CDR loop in a locked state, resulting in collection of robust, high-quality statistics regarding PI.

CDR loop 300 is associated with a single one of ADCs 144. As noted above, transceiver 102 may include multiple instances of the CDR loop 300, where each CDR loop 300 includes a respective ADC 144, PI 220, DLL 230, phase detector 240, loop filter 250, PI-code accumulator 260, and PI-code monitoring and correction subsystem 310. Shared PLL 270 is shared across the multiple CDR loops 300, with each CDR loop 300 receiving CLK 272 from shared PLL 270.

In some implementations, PI-code monitor 320 is not in the pathway of the CDR loop 300 as shown, but instead is implemented as a hanging block at the output of PI-code accumulator 260. In such embodiments, PI-code corrector 330 may not be included. Instead, PI-code monitor 320 receives PI-code 262 and performs the monitoring described below, and in the main CDR loop 300, PI-code accumulator 260 outputs PI code 262 to PI 220, as shown in FIG. 2.

### Example PI-Code Monitor

FIG. 4 illustrates an example implementation of PI-code monitor 320, according to some embodiments of the disclosure. In this example, PI-code monitor 320 includes loop interface 410, data collector 420, count generator 430, and error detector 440.

PI-code monitor 320 receives PI-codes 262 at loop interface 410 and transmits PI-codes 262 to data collector 420. In some embodiments, PI-code monitor 320 determines whether or when to transmit PI-codes 262 to data collector 420. For example, PI-code monitor 320 may look for errors in PI-codes 262 during a calibration or setup phase of transceiver 104. Transceivers 102 and 104 may perform a calibration procedure at startup and/or when a new connection is detected (e.g., communication link 166). Non-linearity in PI-codes generation may be observed in response to changing conditions, e.g., changes in temperature, so a calibration procedure may be performed periodically after communication link 166 is established, e.g., hourly or daily. In some cases, loop interface 410 determines whether a calibration procedure is to be performed (e.g., in response to any of the triggers noted above), and instructs transceiver 104 to initiate calibration.

In other embodiments, loop interface 410 may detect that a calibration procedure is performed in response to determining that a specific data sequence, e.g., low ppm data 302, is being received from transceiver 102. Low ppm data 302 may have a specific data pattern that loop interface 410 recognizes as calibration data. In response to detecting that low ppm data 302 is being received, loop interface 410 transmits PI-codes 262 to data collector 420.

In some embodiments, loop interface 410 may transmit PI-codes 262 to data collector 420 at other times, when low ppm data 302 is not received. In some cases, data collector 420 may store PI-codes 262 on a continual basis, outside of a calibration phase, or on a periodic basis but without specific low ppm data 302 data. In some embodiments, loop interface 410 periodically instructs data collector 420 to clear saved data. Alternatively, data collector 420 may collect PI-codes 262 in a rolling window, deleting the oldest PI-codes 262.

Data collector 420 stores a set of PI-codes 262 received from loop interface 410. Data collector 420 may save a sequence 422 of PI-codes 262 received through a period of time. Data collector 420 may save all PI-codes 262 sent from loop interface 410 until receiving an instruction to delete them, or as noted above, data collector 420 may save PI-codes 262 for a rolling window, deleting the oldest PI-codes 262. Data collector 420 provides PI-code sequence 422 to count generator 430.

Count generator 430 accumulates PI-codes 262 from PI-code sequence 422 into a set of bins. In some embodiments, count generator 430 creates and maintains a bin for each unique PI-code 262. For example, if CDR loop 300 (specifically PI-code accumulator 260 and PI 220) has 256 PI-codes 262, count generator 430 may group the PI-codes 262 into 256 bins, each corresponding to a respective one of the PI-codes 262. In different embodiments, CDR loop 300 may combine a number of PI-codes 262 to generate a different number of bins, e.g., 64, 128, 256, or 512 bins.

In some embodiments, count generator 430 accumulates multiple sequential PI-codes into a single bin. For example, each of the bins may correspond to a respective phase output by DLL 230. FIG. 5 provides a visual representation of PI-codes and grouped PI-codes, according to some embodiments of the disclosure. FIG. 5 includes a first representation of PI-codes 500 arranged in a circle representing different signal phases. In PI-code representation 500, the PI-codes 262 used by the system are represented as different phases, with each PI-code 262 having a small slice of the circle, e.g., 1/256 of the circle. Not all 256 phases are shown, to improve visibility, and the illustrated phases may not be to scale. In grouped PI-code representation 510, eight bins are illustrated. These may correspond to the 8 phase outputs of DLL 230. Each of the bins in grouped PI-code representation 510 includes multiple of the PI-codes 262 represented in PI-codes 500. For example, in the 256 code example, each of the 8 bins in grouped PI-code representation 510 includes 32 PI-codes 262.

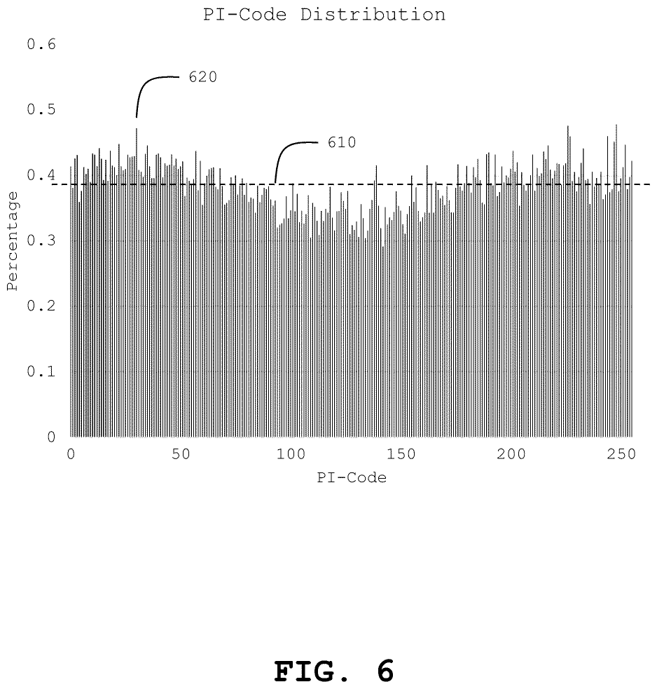

The binned PI-codes 432 generated by count generator 430 may be represented as histograms. FIG. 6 is a first histogram representing a PI-code distribution, according to some embodiments of the disclosure. FIG. 6 includes 256 bins, corresponding to 256 PI-codes 262. In FIG. 6, the histogram is illustrated as a probability density function (PDF) 434 representing the probability of each PI-code 262 across the possible PI-codes 262. To form the PDF 434, counts in each bin have been converted to percentages, i.e., a percentage of the overall number of codes that is in each bin. Count generator 430 may output binned PI-codes 432, including the total number of PI-codes 262 for each bin, and/or PDF 434, which may also be referred to as normalized bin counts.

For 256 bins, ideally, each bin has 0.39% of the total number of binned codes. 0.39% is illustrated as dashed line 610. The actual histogram in FIG. 6 has some bins with greater than 0.39%, e.g., the bin labelled 620 has 0.47%, which is much higher than 0.39%. Other bins are lower than 0.39%. Inconsistency in the PI-code distribution represented in FIG. 6 indicates non-linearity in the PI 220, e.g., non-linear phase interpolation by PI 220.

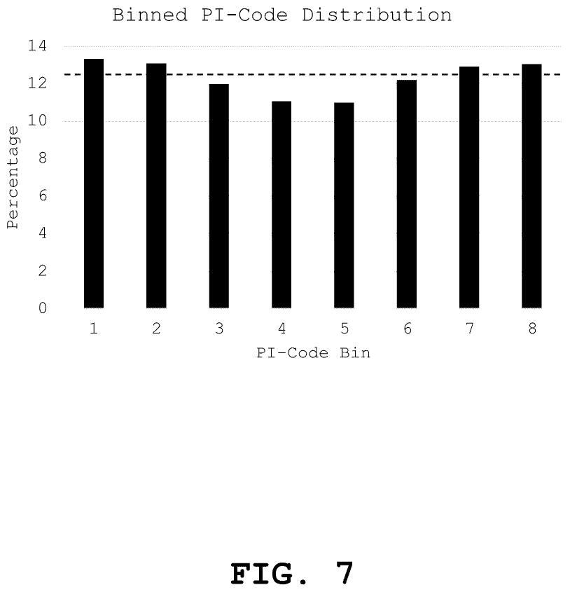

FIG. 7 is a second histogram of the PI-code distribution of FIG. 6 with multiple PI-codes binned together in groups, according to some embodiments of the disclosure. FIG. 7 includes 8 bins, where each bin includes 32 of the 256 PI-codes 262. In FIG. 7, the counts for each bin have been converted to percentages to generate a PDF; for 8 bins, each bin ideally has 12.5% of the total number of binned codes. 12.5% is illustrated as dashed line 710. As in FIG. 6, some bins have percentages over 12.5%, and some bins have percentages below 12.5%. For example, bins 4 and 5 are below dashed line 710. Inconsistency in the PI-code distribution represented in FIG. 7 can represent nonuniform spacing in the phases output by DLL 230.

Error detector 440 receives binned PI-codes 432 and/or PDFs 434 from count generator 430. For example, error detector 440 may receive the two PDFs illustrated visually in FIGS. 6 and 7. Error detector 440 may process the PDFs 434 to identify non-linearities in analog subsystem 210. Error detector 440 may output a signal describing the error, e.g., identifying a source of the error (e.g., PI 220 or DLL 230), or data quantifying a severity of the error. For example, error detector 440 may calculate and output a measurement of differential non-linearity (DNL) or integral non-linearity (INL) based on the single-code PDF (describing non-linearity in PI 220) or DNL or INL based on the grouped PDF (describing non-linearity in DLL 230). Error detector 440 may quantify non-linearity across one or both of the PDFs by reporting a maximum or root mean square (RMS) of the DNLs or INLs across the PDF. Error detector 440 may output this data describing phase errors 442 to PI-code corrector 330 and/or to other monitoring or diagnostic components.

### Example Method for PI-Code Monitoring

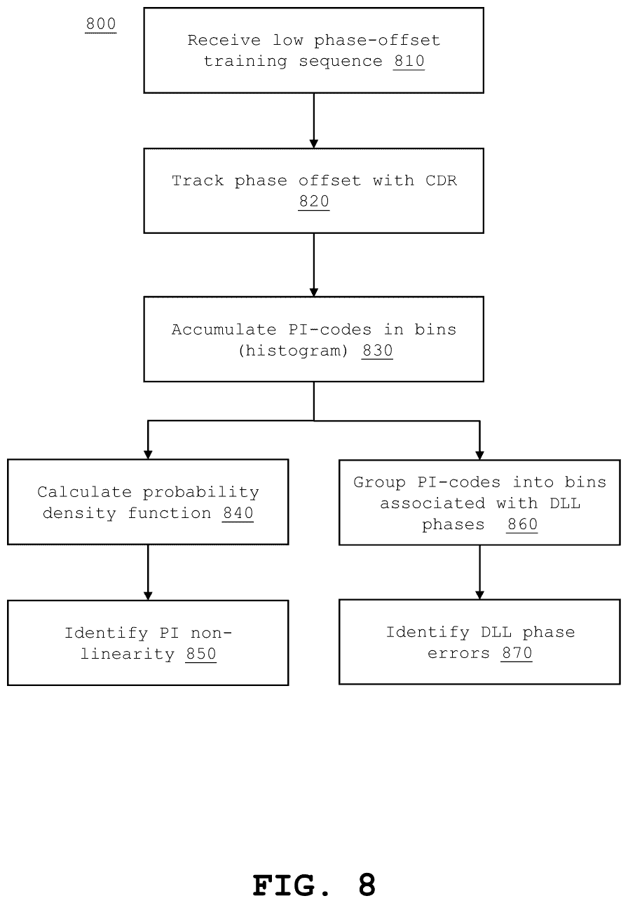

FIG. 8 is a flow chart illustrating a method for PI-code monitoring, according to some embodiments of the present disclosure. Method 800 may be performed by components illustrated in FIGS. 3 and 4. For example, method 800 may be performed by the CDR loop 300 shown in FIG. 3, with several steps performed by PI-code monitor 320, described with respect to FIGS. 3 and 4.

In 810, CDR loop 300 receives a low frequency-offset training sequence from a link partner. For example, ADC 144 receives low ppm data 302. As noted above with respect to FIG. 4, in some embodiments, low ppm data 302 is received during a calibration phase, which may be initiated by loop interface 410. In some embodiments, loop interface 410 may determine that low ppm data 302 is being received, or loop interface 410 may receive a signal from another component indicating the low ppm data 302 is being received or a calibration procedure is being performed.

In 820, CDR loop 300 tracks phase between the received training sequence (e.g., low ppm data 302) and the local sampling clock 274 generated by the phase PI 220. As described above, phase detector 240 compares the digitized received data with a reference clock, outputting a phase error signal to loop filter 250. Loop filter 250 processes this signal to generate a control signal, which is accumulated by PI-code accumulator 260 to produce updated PI-codes 262.

In 830, PI-code monitor 320 accumulates PI-codes 262 into bins, which may be used to build histograms representing the distribution of PI-codes 262 over the calibration period. As described with respect to FIG. 4, data collector 420 stores the sequence of PI-codes 262, and count generator 430 groups them into bins. In this example, each bin corresponds to a unique PI-code (e.g., 256 bins for 256 codes).

In 840, the PDF of the single-bin PI-code distribution is calculated. Count generator 430 converts the bin counts to a PDF 434, as described with respect to FIG. 4. An example single-code PDF is shown in FIG. 6.

In 850, the error detector 440 analyzes the single-code PDF to identify statistical anomalies, such as uneven bin counts or missing codes, which indicate non-ideal phase behavior in the PI 220. Closed-form expressions, such as DNL or INL, may be used to compare the measured PI-code distribution to the ideal uniform distribution, and to quantify PI non-linearity based on the single-bin PDF.

In 860, PI-codes are grouped into bins associated with DLL phases. For example, count generator 430 may combine multiple bins from the single-bin histogram into grouped bins. For example, bins corresponding to PI-codes 0-31 are combined into a first grouped bin, bins corresponding to PI-codes 32-64 are combined into a second grouped bin, and so forth. Count generator 430 may further convert the grouped bin counts into a second PDF 434, such as the PDF illustrated in FIG. 7.

In 870, error detector 440 identifies DLL phase errors by analyzing the grouped histogram or grouped PDF. Nonuniform spacing or irregularities in the grouped bins may indicate phase generation errors in the DLL 230. Closed-form expressions, such as DNL or INL, may be used to compare the grouped PI-code distribution to the ideal uniform distribution, and to quantify DLL non-linearity based on the grouped-bin PDF.

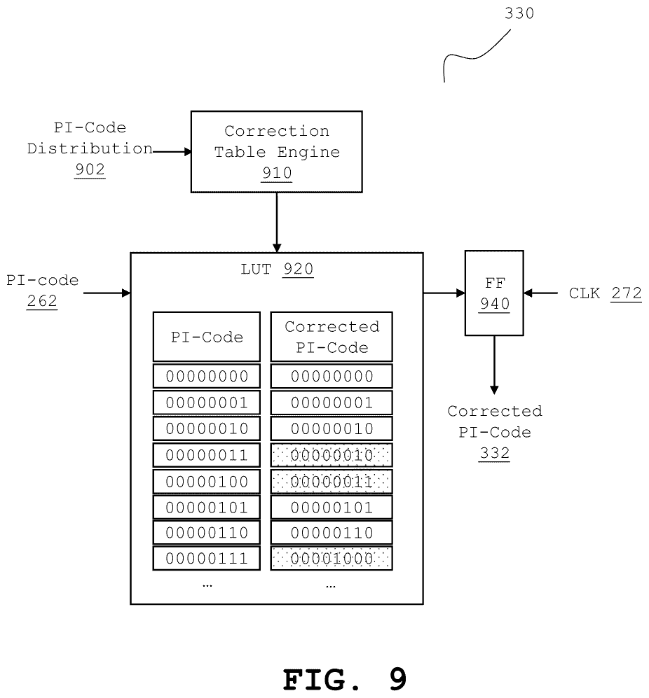

PI-code corrector 330 may output PI and DLL errors identified in steps 850 and/or 870 for use in subsequent correction steps, such as generating a correction table or applying digital compensation via the PI-code corrector 330, as described with respect to FIGS. 9-11. The monitoring results may be used to update the correction table engine and adjust PI-codes in real-time, improving timing alignment and reducing bit error rate in high-speed links.

### Example PI-Code Correctors

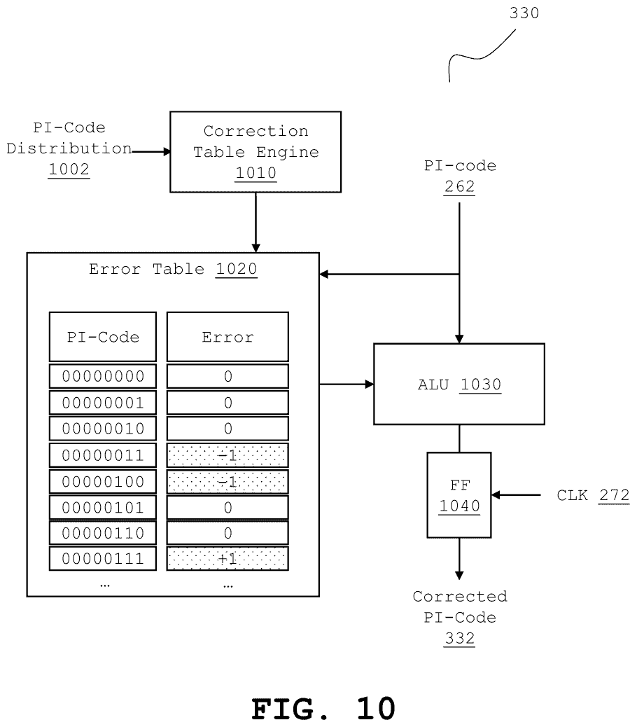

As described with respect to FIG. 4, PI-code corrector 330 can calculate and implement corrections to PI-codes to correct for non-linear behavior in analog subsystem 210, e.g., in PI 220 or DLL 230. In general, PI-code corrector 330 may implement a correction engine and a correction table. The correction engine generates the correction table based on a PI-code distribution, e.g., a PDF 434 generated by count generator 430, and in particular, a PDF with single-PI-code bins, such as the PDF shown in FIG. 6. This PDF may be generated in step 840 of FIG. 8. The correction engine determines a mapping between the actual PI-code distribution and an expected or ideal PI-code distribution, in which each PI-code appears with the same frequency. The correction engine may determine a table for the PI-code corrector 330 to use to adjust incoming PI-codes during normal operation (e.g., after the calibration procedure). The PI-code corrector 330 uses the correction table to change at least some PI-codes to corrected PI-code 332, which PI-code corrector 330 provides to PI 220. In various embodiments, the correction table may be implemented as a lookup table, as shown in FIG. 9, or an error table, as shown in FIG. 10.

FIG. 9 illustrates a first example PI-code corrector 330 with a lookup table, according to some embodiments of the disclosure. In FIG. 9, PI-code corrector 330 includes correction table engine 910, lookup table (LUT) 920, and flip-flop (FF) 940. Correction table engine 910 receives PI-code distribution 902 from PI-code monitor 320. PI-code distribution 902 may be a histogram or PDF, such as the PDF illustrated in FIG. 6. Correction table engine 910 generates LUT 920 based on PI-code distribution 902, and in particular, to correct for non-linearities in PI-code distribution 902.

Example values for LUT 920 are shown in FIG. 9. LUT 920 includes, in the first column, PI-codes, and in the second column, corresponding corrected PI-codes. Some corrected PI-codes are the same as in the PI-code column (e.g., 00000000 is the corrected code for 00000000, 00000001 is the corrected code for 00000001, etc.), while other corrected codes are different from the initial code (e.g., 00000010 is the corrected code for 00000011). Corrected codes that are different from the code in the first column are shaded. Eight example PI-codes and corrected PI-codes are shown in FIG. 9, but the LUT may have 256 rows (for a CDR loop 300 with 256 PI-codes), or another number of rows for different implementations (e.g., 128 or 256).

When a new PI-code 262 is received, PI-code corrector 330 looks up the corrected PI-code corresponding to the received PI-code 262 in the LUT 920 and outputs the corrected PI-code to FF 940. FF 940 delays output of corrected PI-code 332, so that PI-code corrector 330 outputs corrected PI-code 332 to PI 220 at a specific time based on CLK 272.

FIG. 10 provides a second PI-code corrector with an error table, according to some embodiments of the disclosure. In FIG. 10, PI-code corrector 330 includes correction table engine 1010, error table 1020, arithmetic logic unit (ALU) 1030, and flip-flop (FF) 1040. Correction table engine 1010 receives PI-code distribution 1002 from PI-code monitor 320. PI-code distribution 1002 may be a histogram or PDF, such as the PDF illustrated in FIG. 6. Correction table engine 1010 generates error table 1020 based on PI-code distribution 1002, and in particular, to correct for non-linearities in PI-code distribution 1002.

Example values for error table 1020 are shown in FIG. 10. Error table 1020 includes, in the first column, PI-codes, and in the second column, corresponding errors. The errors represented in error table 1020 correspond to the example corrected PI-codes in LUT 920. Some PI-codes have 0 error (e.g., for PI-codes 00000000 and 00000001), while other errors are non-zero, e.g., +1 or −1. In some cases, errors may be greater than 1. Errors that are non-zero are shaded. Eight example PI-codes and associated errors are shown in FIG. 10, but the error table 1020 may have 256 rows (for a CDR 300 with 256 PI-codes), or another number of rows for different implementations (e.g., 128 or 256).

When a new PI-code 262 is received, PI-code corrector 330 looks up the error corresponding to the received PI-code 262 in the error table 1020 and outputs the error to ALU 1030. ALU 1030 also receives PI-code 262 and modifies PI-code 262 based on the corresponding error in the error table to generate the corrected PI-code. For example, for PI-code 00000011, error table 1020 outputs an error of −1, and ALU 1030 adds −1 to PI-code 00000011 (or subtracts 1 from PI-code 00000011) to compensate for the error and generate the corrected PI-code of 00000010. As in FIG. 9, the corrected PI-code is received at FF 1040, and FF 1040 delays output of corrected PI-code 332, so that PI-code corrector 330 outputs corrected PI-code 332 to PI 220 at a specific time based on CLK 272.

### Example Method for PI-Code Correction

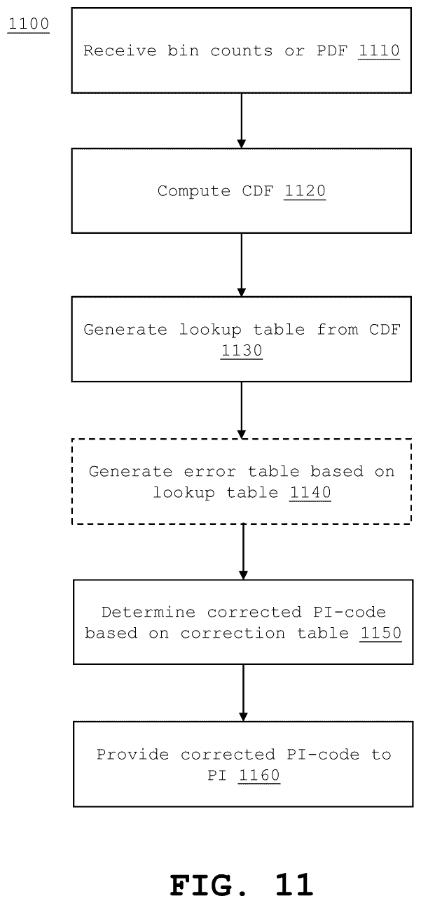

FIG. 11 depicts a flow chart illustrating a method for PI-code correction, according to some embodiments of the disclosure. Method 1100 may be performed by PI-code corrector 330. For example, method 1100 may be performed by the PI-code corrector 330 shown in FIG. 9 or FIG. 10. As noted below, method 1100 includes optional step 1140, which is used by the implementation shown in FIG. 10. Step 1140 may be omitted in the implementation shown in FIG. 9.

In 1110, PI-code corrector 330, e.g., correction table engine 910 or 1010, receives bin counts or a PDF describing a distribution of PI-codes generated during calibration. The bin counts or PDF may be output from PI-code monitor 320, where bin counts and PDF characterize the distribution of PI-codes 262 collected during low ppm calibration.

In 1120, PI-code corrector 330, e.g., correction table engine 910 or 1010, computes a cumulative distribution function (CDF) from received bin counts or PDF. If PI-code monitor 320 outputs bin counts to PI-code corrector 330, correction table engine 910 or correction table engine 1010 may first normalize the bin counts to generate a PDF. Based on the PDF, correction table engine 910 or 1010 generates a CDF, which accumulates the normalized occurrence of PI-codes 262 (from the PDF) up to each PI-code index. The CDF exposes deviation from ideal linear progression attributable to PI 220 non-linearity or DLL 230 phase spacing error.

In 1130, correction table engine 910 or 1010 generates a table from the CDF that maps each PI-code 262 to a corrected PI-code 332 based on target linear phase progression. A corrected PI-code can be calculated from the CDF by multiplying each row of the CDF by the number of unique PI-codes (N), rounding this value, and subtracting 1.

In other embodiments, correction table engine 910 or correction table engine 1010 may arrive at this result using other computational methods. In the example PI-code corrector 330 of FIG. 9, correction table engine 910 stores the corrected PI-code in LUT 920.

In the example PI-code corrector 330 of FIG. 10, in 1140, correction table engine 1010 generates error table 1020 based on the corrected PI-codes generated in 1130. Correction table engine 1010 computes per-code error as follows:

Error=PI-Code−Corrected PI-Code

Correction table engine 1010 stores signed error values in error table 1020 for subsequent arithmetic adjustment in PI-code corrector 330 by ALU 1030.

Based on the example tables in FIGS. 9 and 10, which show the first 8 PI-codes in an example where N=256, the table below illustrates calculations of the corrected PI-codes shown in LUT 920 and the error values shown in error table 1020. Note that PI-codes and corrected PI-codes are represented in decimal numerals, rather than binary as in FIGS. 9 and 10.

| PI-Code | PDF | CDF | CDF*N | Corrected PI-Code | Error |
|---|---|---|---|---|---|
| 0 | 0.0043 | 0.0043 | 1.1008 | 0 | 0 |
| 1 | 0.0038 | 0.0081 | 2.0736 | 1 | 0 |
| 2 | 0.0034 | 0.01152 | 2.94912 | 2 | 0 |
| 3 | 0.0021 | 0.01364 | 3.49184 | 2 | −1 |
| 4 | 0.0037 | 0.01736 | 4.44416 | 3 | −1 |
| 5 | 0.0057 | 0.0231 | 5.9136 | 5 | 0 |
| 6 | 0.0052 | 0.02827 | 7.23712 | 6 | 0 |
| 7 | 0.0065 | 0.03479 | 8.90624 | 8 | 1 |

In 1150, PI-code corrector 330 determines corrected PI-code 332 from correction table, selecting corrected PI-code 332 directly via lookup table 920 or applying error from error table 1020 using ALU 1030 to modify PI-code 262 received from PI-code accumulator 260. For example, if the PI-code corrector 330 in FIG. 10 receives a PI-code of 3, error table 1020 outputs the error value of −1, and ALU 1030 calculates corrected PI-code 332 as follows:

$$Corrected PI - code = PI - Code + Error = 3 + ( - 1 ) = 2$$

In 1160, flip-flop 940 or flip-flop 1040 provides corrected PI-code 332 to PI 220 synchronously with a signal from DLL 230, e.g., latching corrected PI-code 332 and forwarding it to PI 220 on CLK 272 so that PI 220 interpolates DLL 230 phases with compensated linearity during timing recovery.

### Select Examples

Example 1 provides a method for detecting non-linearity in a clock and data recovery (CDR) loop, the method including receiving a plurality of codes generated by the CDR loop; accumulating the plurality of codes in a plurality of bins, where one of the bins corresponds to one or more of the plurality of codes, each bin having an associated count; and detecting a non-linearity in the CDR loop based on different counts across the plurality of bins, the non-linearity associated with one of the plurality of bins.

Example 2 provides the method of example 1, where the plurality of codes are PI-codes used by a phase interpolator (PI) to interpolate phases output by a delay-locked loop (DLL).

Example 3 provides the method of example 2, where the DLL receives a clock signal from a phase-locked loop (PLL), the PLL shared by a plurality of CDR loops, each of the plurality of CDR loops including a respective PI and DLL.

Example 4 provides the method of example 2 or 3, where each of the bins corresponds to multiple sequential codes, and each bin corresponds to a different phase output by the DLL.

Example 5 provides the method of example 4, where detecting the non-linearity in the CDR loop includes detecting nonuniform spacing in the phases output by the DLL based on the different bin counts.

Example 6 provides the method of any of examples 1-3, where each of the bins corresponds to one or the plurality of codes.

Example 7 provides the method of example 6, where detecting the non-linearity in the CDR loop includes detecting non-linear phase interpolation by a phase interpolator (PI) based on the different bin counts.

Example 8 provides the method of any of examples 1-7, further including receiving a calibration signal from a link partner, where the plurality of codes are accumulated into the plurality of bins while the calibration signal is received.

Example 9 provides the method of any of examples 1-8, further including adjusting another code generated by the CDR loop to mitigate the non-linearity.

Example 10 provides the method of example 9, further including generating a table for code correction based on the counts of the plurality of bins, where the another code is adjusted based on the table.

Example 11 provides a device for detecting phase interpolation errors in a clock and data recovery (CDR) loop, the device including means for receiving a plurality of codes generated by the CDR loop; means for accumulating the plurality of codes in a plurality of bins, where one of the bins corresponds to one or more of the codes, each bin having an associated count; and means for determining that one of the bins has a different count from another one of the bins, the different counts associated with a phase interpolation error at the PI.

Example 12 provides the device of example 11, where each of the plurality of bins corresponds to a plurality of codes.

Example 13 provides the device of example 11 or 12, further including means for modifying a sequence of codes provided to a phase interpolator (PI) based on the phase interpolation error.

Example 14 provides the device of any of examples 11-13, further including means for generating a reference clock signal used by the CDR loop, where the reference clock signal is shared by a plurality of CDR loops.

Example 15 provides the device of any of examples 11-14, where the PI is implemented by analog circuitry, and the means for accumulating the plurality of codes is implemented in digital circuitry.

Example 16 provides the device of any of examples 11-15, where the plurality of codes are generated based on a calibration signal having a frequency that is offset relative to a sampling clock generated by the PI.

Example 17 provides a receiver configured to detect non-linearity in a clock and data recovery (CDR) loop, the receiver including an analog subsystem including an analog-to-digital converter (ADC); and a phase interpolator (PI) coupled to the ADC, the PI to generate a phase-adjusted clock signal for the ADC based on a PI-code; and a PI-code accumulator in the CDR loop, the PI-code accumulator to generate a PI-code used by the PI to select a phase offset for the phase-adjusted clock signal; and a PI-code monitor coupled to the PI-code accumulator, the PI-code monitor to collect a plurality of PI-codes generated by the PI-code accumulator, and to analyze the plurality of PI-codes to identify non-linearity in the phase-adjusted clock signal generated by the PI.

Example 18 provides the receiver of example 17, where the CDR is a first CDR loop, the receiver further includes a second CDR loop including a second ADC, a second PI, a second PI-code accumulator, and a second PI-code monitor.

Example 19 provides the receiver of example 18, where the receiver further includes a phase-locked loop (PLL) to provide a clock signal to the first CDR loop and the second CDR loop.

Example 20 provides the receiver of any of examples 17-19, where the analog subsystem further includes a delay-lock loop (DLL) to generate a reference clock phase for the PI, where the PI is to generate the phase-adjusted clock signal based on the reference clock phase.

Example 21 provides the receiver of any of examples 17-20, where the CDR loop further includes a phase detector and a loop filter, where the PI-code accumulator receives a control signal from the loop filter and generates the PI-code based on the control signal.

Example 22 provides the receiver of any of examples 17-21, where PI-code monitor is to analyze the plurality of PI-codes in response to the CDR loop receiving a calibration signal, the calibration signal having an expected frequency offset relative to the clock signal generated by the PI.

Example 23 provides the receiver of example 17, where PI-code monitor includes a data collector to collect the plurality of PI-codes generated by the PI-code accumulator; a count generator to bin the collected PI-codes into a plurality of bins; and an error detector to identify the non-linearity in the phase-adjusted clock signal based on different counts in the plurality of bins.

Example 24 provides a method for correcting non-linear behavior in analog components of a clock and data recovery (CDR) loop, the method including receiving data describing a distribution of codes generated by the CDR loop, the codes to control a phase interpolator (PI) of a receiver; generating a correction table based on non-linearity in the distribution; receiving a code for the PI; and determining a corrected code for the PI, the corrected code associated with the received code in the correction table.

Example 25 provides the method of example 24, where the distribution of codes is generated during a calibration procedure, and the code for the PI is received after the calibration procedure.

Example 26 provides the method of example 24 or 25, where the correction table is a lookup table that maps a plurality of codes to a respective plurality of corrected codes.

Example 27 provides the method of example 26, where generating the lookup table includes calculating a cumulative distribution function (CDF) of the plurality of codes based on the distribution of codes; calculating the corrected code for each of the plurality of codes based on the CDF; and storing the corrected codes in the lookup table.

Example 28 provides the method of example 24 or 25, where the correction table is an error table that maps a plurality of codes to a respective error for each of the plurality of codes.

Example 29 provides the method of example 28, where generating the error table includes calculating a cumulative distribution function (CDF) of the plurality of codes based on the distribution of codes; calculating the corrected code for each of the codes based on the CDF; calculating an error for each of the codes based on a difference, for a given code, between the code and the corrected code; and storing the errors in the error table.

Example 30 provides the method of example 28 or 29, where determining a corrected code for the PI includes identifying the error associated with the received code in the error table; and adding the error to the received code to generate the corrected code.

Example 31 provides the method of any of examples 24-30, where the corrected code is a PI-code used by the PI to interpolate phases output by a delay-locked loop (DLL).

Example 32 provides the method of any of examples 24-30, where the DLL receives a clock signal from a phase-locked loop (PLL), the PLL shared by a plurality of CDR loops, each of the plurality of CDR loops including a respective PI and DLL.

Example 33 provides a device for compensating phase interpolation errors in a clock and data recovery (CDR) loop, the device including means for generating a correction table based on a distribution of phase interpolator (PI)-codes generated by the CDR loop, where the correction table corrects a non-linearity in the distribution; means for receiving a PI-code for a PI; and means for selecting a corrected PI-code for the PI, the corrected PI-code associated with the received PI-code in the correction table.

Example 34 provides the device of example 33, further including means for generating a reference clock signal used by the CDR loop, where the reference clock signal is shared by a plurality of CDR loops.

Example 35 provides the device of example 33 or 34, where the PI is implemented by analog circuitry, and the means for selecting the corrected PI-code is implemented in digital circuitry.

Example 36 provides the device of any of examples 33-35, where the correction table is a lookup table that maps a plurality of PI-codes to a respective plurality of corrected PI-codes.

Example 37 provides the device of example 36, where means for generating the lookup table includes means for calculating a cumulative distribution function (CDF) of the plurality of PI-codes based on the distribution of PI-codes; means for calculating the corrected PI-codes for each of the plurality of PI-codes based on the CDF; and means for storing the corrected PI-codes in the lookup table.

Example 38 provides the device of any of examples 33-35, where the correction table is an error table that maps a plurality of PI-codes to a respective error for each of the plurality of PI-codes.

Example 39 provides the device of example 38, where means for generating the error table includes means for calculating a cumulative distribution function (CDF) of the plurality of PI-codes based on the distribution of PI-codes; means for calculating the corrected PI-codes for each of the PI-codes based on the CDF; means for calculating an error for each of the PI-codes based on a difference, for a given PI-codes, between the PI-code and the corrected PI-code; and means for storing the calculated errors in the error table.

Example 40 provides the device of example 38 or 39, where the means for selecting the corrected PI-code for the PI includes means for identifying an error associated with the received PI-code in the error table; and means for adding the error to the received PI-code to generate the corrected PI-code.

Example 41 provides a receiver configured to correct non-linearity in a clock and data recovery (CDR) loop, the receiver including an analog subsystem including an analog-to-digital converter (ADC); and a phase interpolator (PI) coupled to the ADC, the PI to generate a phase-adjusted clock signal for the ADC based on a PI-code; and a PI-code accumulator in the CDR loop, the PI-code accumulator to generate a PI-code for the PI to select a phase offset for the phase-adjusted clock signal; and a PI-code corrector coupled between the PI-code accumulator and the PI, the PI-code corrector to generate a corrected PI-code based on the PI-code from the PI-code accumulator, where the corrected PI-code corrects for a non-linearity in the PI.

Example 42 provides the receiver of example 41, where the PI-code corrector includes a correction table that maps a plurality of PI-codes to corrections for the plurality of PI-codes.

Example 43 provides the receiver of example 42, where the PI-code corrector further includes a flip-flop, the flip-flop to store the corrected PI-code based on the correction table and output the corrected PI-code to the PI based on a clock signal.

Example 44 provides the receiver of example 42 or 43, where the correction table is a lookup table that maps the PI-code from the PI-code accumulator to the corrected PI-code.

Example 45 provides the receiver of example 42 or 43, where the correction table is an error table that maps the PI-code from the PI-code accumulator to an error associated with the PI-code, and the PI-code corrector further includes an arithmetic logic unit (ALU) to modify the PI-code based on the error.

Example 46 provides the receiver of any of examples 42-45, where the PI-code corrector further includes a correction table engine to generate the correction table based on a distribution of PI-codes received during a calibration phase.

Example 47 provides the receiver of example 46, where the correction table engine is further to update the correction table based on an additional distribution of PI-codes.

Example 48 provides the receiver of any of examples 41-47, where the CDR is a first CDR loop, the receiver further includes a second CDR loop including a second ADC, a second PI, a second PI-code accumulator, and a second PI-code corrector.

Example 49 provides the receiver of example 48, where the receiver further includes a phase-locked loop (PLL) to provide a clock signal to the first CDR loop and the second CDR loop.

Example 50 provides an apparatus comprising means for performing any one of the method of examples 1-10 and 24-32.

Example 51 provides a transmitter having a transmit portion and a digital signal processor according to any one of examples 11-23 and 33-49.

Example 23 provides a receiver having a receive portion and a digital signal processor according to any one of examples 11-23 and 33-49.

Example 24 provides a transceiver having a transmit portion, a receive portion, and a digital signal processor according to any one of examples 11-23 and 33-49.

### VARIATIONS AND OTHER NOTES

The detailed description, such as the “Select examples” section, provide various examples of the embodiments disclosed herein.

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method for correcting non-linear behavior in analog components of a clock and data recovery (CDR) loop, the method comprising:
receiving data describing a distribution of codes generated by the CDR loop;
generating a correction table based on non-linearity in the distribution;
receiving a code for a phase interpolator (PI); and
determining a corrected code for the PI, the corrected code associated with the received code in the correction table.

2. The method of claim 1, wherein the distribution of codes is generated during a calibration procedure, and the code for the PI is received after the calibration procedure.

3. The method of claim 1, wherein the correction table is a lookup table that maps a plurality of codes to a respective plurality of corrected codes.

4. The method of claim 3, wherein generating the lookup table comprises:
calculating a cumulative distribution function (CDF) of the plurality of codes based on the distribution of codes;
calculating the corrected code for each of the plurality of codes based on the CDF; and
storing the corrected codes in the lookup table.

5. The method of claim 1, wherein the correction table is an error table that maps a plurality of codes to a respective error for each of the plurality of codes.

6. The method of claim 5, wherein generating the error table comprises:
calculating a cumulative distribution function (CDF) of the plurality of codes based on the distribution of codes;
calculating the corrected code for each of the codes based on the CDF;
calculating an error for each of the codes based on a difference, for a given code, between the code and the corrected code; and
storing the errors in the error table.

7. The method of claim 5, wherein determining a corrected code for the PI comprises:
identifying the error associated with the received code in the error table; and
adding the error to the received code to generate the corrected code.

8. The method of claim 1, wherein the corrected code is a PI-code used by the PI to interpolate phases output by a delay-locked loop (DLL).

9. A device for compensating phase interpolation errors in a clock and data recovery (CDR) loop, the device comprising:
means for generating a correction table based on a distribution of phase interpolator (PI)-codes generated by the CDR loop, wherein the correction table corrects a non-linearity in the distribution;
means for receiving a PI-code for a PI; and
means for selecting a corrected PI-code for the PI, the corrected PI-code associated with the received PI-code in the correction table.

10. The device of claim 9, further comprising means for generating a reference clock signal used by the CDR loop, wherein the reference clock signal is shared by a plurality of CDR loops.

11. The device of claim 9, wherein the PI is implemented by analog circuitry, and the means for selecting the corrected PI-code is implemented in digital circuitry.

12. The device of claim 9, wherein the correction table is a lookup table that maps a plurality of PI-codes to a respective plurality of corrected PI-codes.

13. The device of claim 12, wherein means for generating the lookup table comprises:
means for calculating a cumulative distribution function (CDF) of the plurality of PI-codes based on the distribution of PI-codes;
means for calculating the corrected PI-codes for each of the plurality of PI-codes based on the CDF; and
means for storing the corrected PI-codes in the lookup table.

14. The device of claim 9, wherein the correction table is an error table that maps a plurality of PI-codes to a respective error for each of the plurality of PI-codes.

15. The device of claim 14, wherein means for generating the error table comprises:
means for calculating a cumulative distribution function (CDF) of the plurality of PI-codes based on the distribution of PI-codes;
means for calculating the corrected PI-codes for each of the PI-codes based on the CDF;
means for calculating an error for each of the PI-codes based on a difference, for a given PI-code, between the PI-code and the corrected PI-code; and
means for storing the calculated errors in the error table.

16. A receiver configured to correct non-linearity in a clock and data recovery (CDR) loop, the receiver comprising:
an analog subsystem comprising:
an analog-to-digital converter (ADC); and
a phase interpolator (PI) coupled to the ADC, the PI to generate a phase-adjusted clock signal for the ADC based on a PI-code;
a PI-code accumulator in the CDR loop, the PI-code accumulator to generate a PI-code for the PI to select a phase offset for the phase-adjusted clock signal; and
a PI-code corrector coupled between the PI-code accumulator and the PI, the PI-code corrector to generate a corrected PI-code based on the PI-code from the PI-code accumulator, wherein the corrected PI-code corrects for a non-linearity in the PI.

17. The receiver of claim 16, wherein the PI-code corrector comprises a correction table that maps a plurality of PI-codes to corrections for the plurality of PI-codes.

18. The receiver of claim 17, wherein the correction table is a lookup table that maps the PI-code from the PI-code accumulator to the corrected PI-code.

19. The receiver of claim 17, wherein the correction table is an error table that maps the PI-code from the PI-code accumulator to an error associated with the PI-code, and the PI-code corrector further comprises an arithmetic logic unit (ALU) to modify the PI-code based on the error.

20. The receiver of claim 17, wherein the PI-code corrector further comprises a correction table engine to generate the correction table based on a distribution of PI-codes received during a calibration phase.
